(19) United States
(12) Patent Application Publication
(10) Pub. No.: US 2025/0252304 A1
(43) Pub. Date: Aug. 7, 2025

(54) METHOD FOR MODEL TUNING AND SYSTEM THEREFOR

(71) Applicant: SAMSUNG SDS CO., LTD., Seoul (KR)

(72) Inventors: Seung Ki HONG, Seoul (KR); Tae Young JANG, Seoul (KR); Ji Hyung YOUN, Seoul (KR)

(73) Assignee: SAMSUNG SDS CO., LTD., Seoul (KR)

(21) Appl. No.: 19/043,854

(22) Filed: Feb. 3, 2025

(30) Foreign Application Priority Data
Feb. 2, 2024 (KR) 10-2024-0016377

(51) Int. Cl. G06N 3/08; G06N 3/04

(52) U.S. Cl. CPC G06N 3/08; G06N 3/04

(57) ABSTRACT

A method for model tuning and a system therefor are provided. The method according to some embodiments may include obtaining a deep learning model into which an adapter is inserted, wherein the adapter is a module inserted to adjust the output of the deep learning model using a plurality of weight matrices, and the plurality of weight matrices include a diagonal weight matrix, calculating loss by performing a specific task on the deep learning model and updating the plurality of weight matrices of the adapter based on the loss.

### CROSS-REFERENCE TO RELATED APPLICATION

This application claims priority from Korean Patent Application No. 10-2024-0016377, filed on Feb. 2, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for model tuning and system therefor, and more specifically, to a method and system for tuning a deep-learning model in a cost-effective manner.

### 2. Description of the Related Art

Recently, interest in large language models (LLMs) has significantly increased across various fields. LLMs contain a substantial number of parameters (e.g., over 7 billion parameters) to possess a universal understanding of natural language. The scale of LLMs (i.e., the number of parameters) continues to grow.

LLMs are typically built through a pretraining and fine-tuning process. The fine-tuning process involves further updating the pretrained parameters of an LLM using a dataset of a specific domain or problem, thereby enhancing the LLM's performance.

However, due to the vast number of parameters in LLMs, even the fine-tuning process requires considerable computational costs, which is one of the primary factors limiting the usability of LLMs.

### SUMMARY

An objective of the present disclosure is to provide a method and system for tuning a deep-learning model in a cost-effective manner. For example, this objective aims to provide a method and system for tuning a large-scale deep-learning model (e.g., a large language model (LLM)) at a lower cost.

Another objective of the present disclosure is to provide a method and system for constructing a high-performance deep-learning model suitable for a target task (or domain).

Another objective of the present disclosure is to provide a method and system for accurately measuring the impact of adapter parameters inserted into a deep-learning model on a given task.

Another objective of the present disclosure is to provide a method and system for effectively filtering non-critical parameters based on the impact of adapter parameters on a given task.

The objectives of the present disclosure are not limited to those mentioned above, and other objectives not explicitly stated will be clearly understood by those skilled in the art based on the following description.

According to an aspect of the present disclosure, there is provided a method for model tuning performed by at least one processor. The method may include obtaining a deep learning model into which an adapter is inserted, wherein the adapter is a module inserted to adjust the output of the deep learning model using a plurality of weight matrices, and the plurality of weight matrices include a diagonal weight matrix, calculating loss by performing a specific task on the deep learning model and updating the plurality of weight matrices of the adapter based on the loss.

In some embodiments, wherein the adapter may include a down-projection module that performs a down-projection operation using some of the plurality of weight matrices, a non-linear layer that performs a non-linear transformation on a result of the down-projection operation and an up-projection module that performs an up-projection operation on a result of the non-linear transformation using other weight matrices of the plurality of weight matrices.

In some embodiments, the plurality of weight matrices may further include a first weight matrix and a second weight matrix that are connected to the diagonal weight matrix through a multiplication operation, the diagonal weight matrix may be an r×r matrix where r is a natural number, the first weight matrix may be an m×r matrix where m is a natural number, the second weight matrix may be an r×n matrix where n is a natural number, and a value of r may be set to be smaller than values of m and n.

In some embodiments, the deep learning model may include a transformer layer, the transformer layer may include an attention module and a feed-forward layer, and the adapter may be inserted after the feed-forward layer and configured to adjust the output of the feed-forward layer.

In some embodiments, the deep learning model may include a plurality of neural network layers, the adapter may be inserted to adjust the output of a first neural network layer among the plurality of neural network layers, and another adapter may be further inserted into the deep learning model to adjust the output of a second neural network layer among the plurality of neural network layers.

In some embodiments, the plurality of weight matrices may further include a first weight matrix and a second weight matrix that are connected to the diagonal weight matrix through a multiplication operation, and the calculating the loss may include deriving task loss by performing the specific task, calculating a penalty value to impose orthogonality on at least one of the first weight matrix or the second weight matrix and calculating the loss based on the task loss and the penalty value.

In some embodiments, the diagonal weight matrix may include a plurality of diagonal elements, and the model may further include calculating an impact of each of the plurality of diagonal elements on a predicted label for the specific task based on a gradient between a value of the predicted label and each of the plurality of diagonal elements and setting a value of any diagonal element whose impact falls below a threshold to zero.

In some embodiments, the updating the plurality of weight matrices may include updating the plurality of weight matrices while keeping at least part of the deep learning model frozen.

In some embodiments, the adapter may be a first adapter, and the method may further include inserting a second adapter into the deep learning model and updating the second adapter by performing a different task, performing the specific task using the deep learning model with the updated first adapter inserted thereinto, removing the updated first adapter from the deep learning model and inserting the updated second adapter into the deep learning model and performing the different task using the deep learning model with the updated second adapter inserted thereinto.

According to another aspect of the present disclosure, there is provided a system for model tuning. The system may include at least one processor and a memory configured to store a computer program executed by the at least one processor, wherein the computer program comprises instructions for performing operations of obtaining a deep learning model into which an adapter is inserted, wherein the adapter is a module inserted to adjust an output of the deep learning model using a plurality of weight matrices, and the plurality of weight matrices include a diagonal weight matrix, calculating loss by performing a specific task on the deep learning model and updating the plurality of weight matrices of the adapter based on the loss.

According to yet another aspect of the present disclosure, there is provided a non-transitory computer-readable recording medium storing a computer program, which, when executed by at least one processor, causes the at least one processor to perform obtaining a deep learning model into which an adapter is inserted, wherein the adapter is a module inserted to adjust an output of the deep learning model using a plurality of weight matrices, and the plurality of weight matrices include a diagonal weight matrix, calculating loss by performing a specific task on the deep learning model and updating the plurality of weight matrices of the adapter based on the loss.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram for explaining the operation of a model tuning system at a system level according to some embodiments of the present disclosure;

FIG. 2 is a diagram for explaining the concept of adapter-based model tuning according to some embodiments of the present disclosure;

FIG. 3 is a diagram for explaining a case in which a plurality of adapters are inserted into a deep learning model according to some embodiments of the present disclosure;

FIG. 4 is a diagram for explaining the configuration (or structure) and operation of an adapter according to some embodiments of the present disclosure;

FIGS. 5 and 6 are diagrams for explaining the forms and characteristics of weight matrices held by an adapter according to some embodiments of the present disclosure;

FIG. 7 is a flowchart illustrating a model tuning method according to some embodiments of the present disclosure;

FIGS. 8 and 9 are diagrams for explaining the structure of a deep learning model and the insertion positions of adapters according to some embodiments of the present disclosure;

FIG. 10 is a detailed flowchart illustrating the learning step shown in FIG. 7;

FIG. 11 is a diagram for further explaining the detailed process of the learning step shown in FIG. 10;

FIG. 12 is a diagram for further explaining the total loss calculation step shown in FIG. 10;

FIG. 13 is a diagram for explaining an adapter parameter filtering method according to some embodiments of the present disclosure;

FIGS. 14 and 15 are diagrams for explaining an adapter replacement-based target task execution method according to some embodiments of the present disclosure; and

FIG. 16 illustrates an exemplary computing device capable of implementing the model tuning system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

Various embodiments of the present disclosure will hereinafter be described with reference to the accompanying drawings.

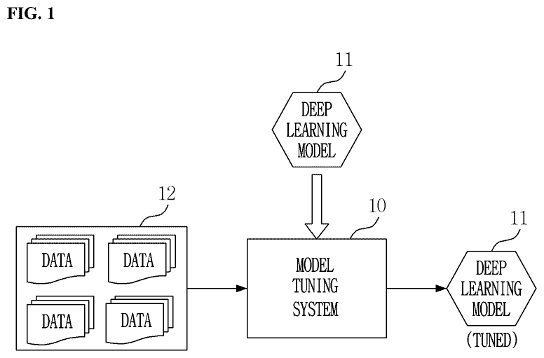

FIG. 1 is a diagram for explaining the operation of a model tuning system 10 at a system level according to some embodiments of the present disclosure.

As illustrated in FIG. 1, the model tuning system 10 is a computing device/system equipped with a tuning function for a deep learning model 11. For example, the model tuning system 10 may fine-tune a pretrained deep learning model 11 by executing predefined tasks based on a dataset 12 (e.g., a training set).

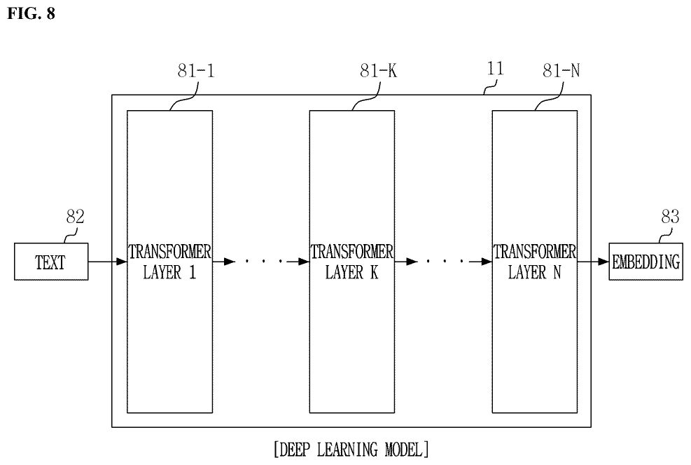

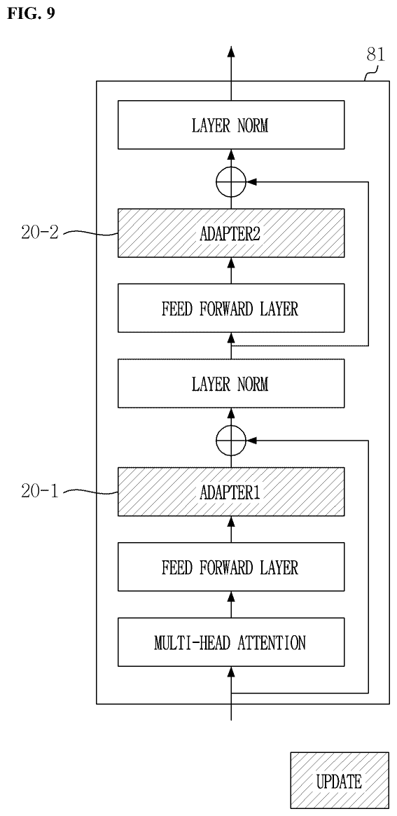

The deep learning model 11, which is a target model for tuning, may be any pretrained deep learning model. The deep learning model 11 may be a model with a substantial number of parameters (i.e., trainable/learnable parameters). A typical example of the deep learning model 11 is a large-scale language model (LLM). However, the present disclosure is not limited to this. A case where the deep learning model 11 is a transformer-based LLM will be described later with reference to FIGS. 8 and 9.

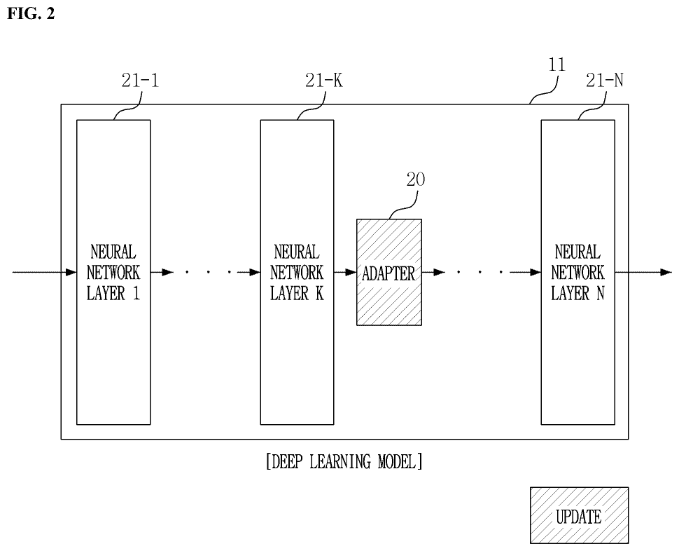

As illustrated in FIG. 2, the deep learning model 11 may be composed of a plurality of neural network layers 21-1 through 21-N (e.g., transformer layers). However, the present disclosure is not limited to this.

Specifically, as illustrated in FIG. 2, the model tuning system 10 may tune the deep learning model 11 by updating the parameters of an adapter 20 inserted into the deep learning model 11 instead of updating all the parameters of the deep learning model 11. For example, the model tuning system 10 may update only the parameters of the adapter 20 while keeping all the parameters of the deep learning model 11 frozen, or may update only some of the parameters of the deep learning model 11 (e.g., the parameters of neural network layers adjacent to the adapter 20 or the parameters of key neural network layers) along with the adapter 20. In the drawings subsequent to FIG. 2, modules related to “UPDATE” (e.g., the adapter 20) refer to modules that are updated during a tuning process, and FIG. 2 illustrates a case where all the parameters of the deep learning model 11 are frozen during the tuning process.

The adapter 20 refers to a lightweight neural network module inserted to adjust the output of the deep learning model 11. Specifically, the purpose of using the adapter 20 can be understood as enabling a more cost-effective tuning of the deep learning model 11 (e.g., tuning the deep learning model 11 for a target task) by updating the parameters of the adapter 20 instead of all the parameters of the deep learning model 11. The structure and operation of the adapter 20 will be described later with reference to FIGS. 4 through 6.

The number of adapters 20 inserted and their insertion positions may vary. For example, a single adapter 20 or multiple adapters 20 may be inserted into the deep learning model 11.

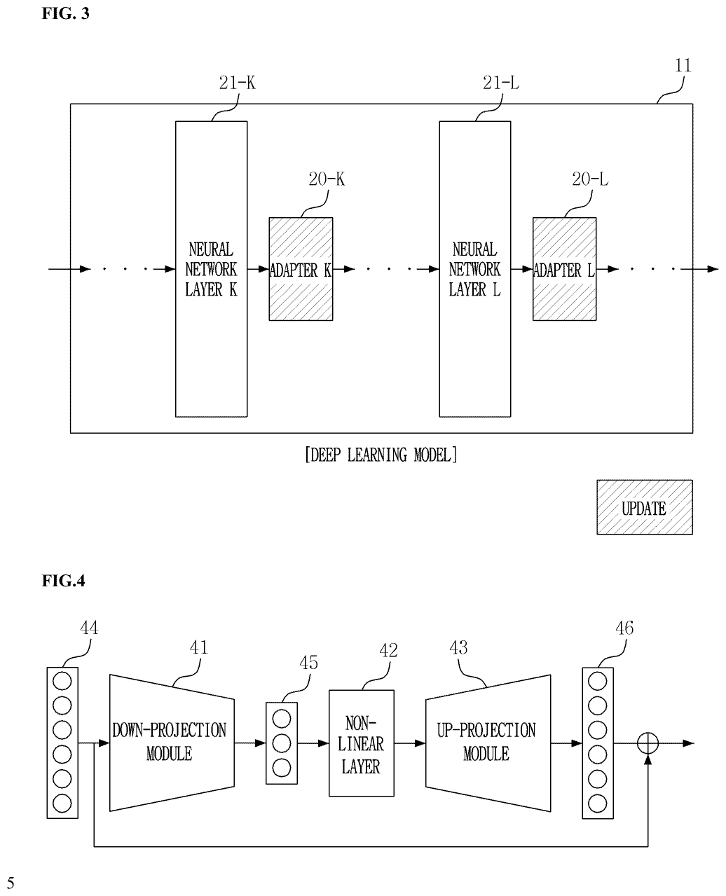

In some embodiments, as illustrated in FIG. 3, one or more adapters (e.g., a K-th adapter 20-K or an L-th adapter 20-L) may be inserted (or placed) in the neural network layers (e.g., a K-th neural network layer 21-K and an L-th neural network layer 21-L) of the deep learning model 11. For example, the K-th adapter 20-K may be inserted to adjust the output of the K-th neural network layer 21-K (where K is a natural number), and the L-th adapter 20-L may be inserted to adjust the output of the L-th neural network layer 21-L (where L is a natural number greater than K). In this manner, output adjustments can be respectively made in multiple neural network layers (e.g., the K-th and L-th neural network layers 21-K and 21-L), resulting in more precise adjustment of the output of the deep learning model 11. Here, the insertion of an adapter (e.g., the K-th adapter 20-K) into a neural network layer (e.g., the K-th neural network layer 21-K) means that the adapter is inserted at any position (either inside or outside the neural network layer) that can adjust the output of the neural network layer.

Reference numeral 20 will be used hereinafter to refer to any individual adapter (e.g., the K-th or L-th adapter 20-K or 20-L) or multiple adapters (e.g., the K-th and L-th adapters 20-K and 20-L) collectively.

The model tuning system 10 may be implemented with at least one computing device. For example, all functions of the model tuning system 10 may be implemented in a single computing device, or first and second functions of the model tuning system 10 may be implemented in first and second computing devices, respectively. Alternatively, a specific function of the model tuning system 10 may be implemented across multiple computing devices.

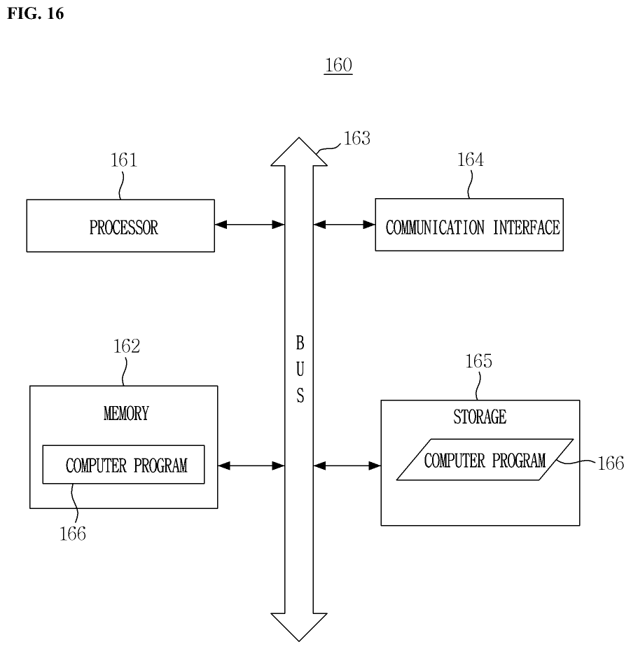

Here, the term “computing device” may include any device equipped with computing functionality, and an exemplary computing device is illustrated in FIG. 16. Since a computing device is a collection of various components (e.g., memories, processors, etc.) that interact with each other, it may sometimes be referred to as a “computing system.” Additionally, a computing system may refer to a collection of multiple computing devices that interact with each other.

Thus far, the operation of the model tuning system 10 according to some embodiments of the present disclosure has been briefly described with reference to FIGS. 1 through 3. Before describing various methods that may be performed in the model tuning system 10, the structure and operation of an adapter 20 will first be explained hereinafter for ease of understanding.

FIG. 4 is a diagram for explaining the structure and operation of an adapter 20 according to some embodiments of the present disclosure.

As illustrated in FIG. 4, the adapter 20 may be composed of a down-projection module 41, a non-linear layer 42, and an up-projection module 43. However, the present disclosure is not limited to this. In other embodiments, the adapter 20 may be configured differently from what is illustrated in FIG. 4.

The down-projection module 41 is a module that performs a down-projection operation (i.e., a projection operation involving dimensional reduction). For example, the down-projection module 41 may transform input data 44 (e.g., a vector) into lower-dimensional data 45 (e.g., a vector with fewer elements). The down-projection module 41 may be implemented based on at least one linear layer, but the present disclosure is not limited thereto.

Here, the term “linear layer” may also be referred to as a “projection layer,” a “fully-connected layer,” or a “feed-forward layer.” Additionally, the term “layer” may be used interchangeably with terms such as “block,” “module,” or “unit.”

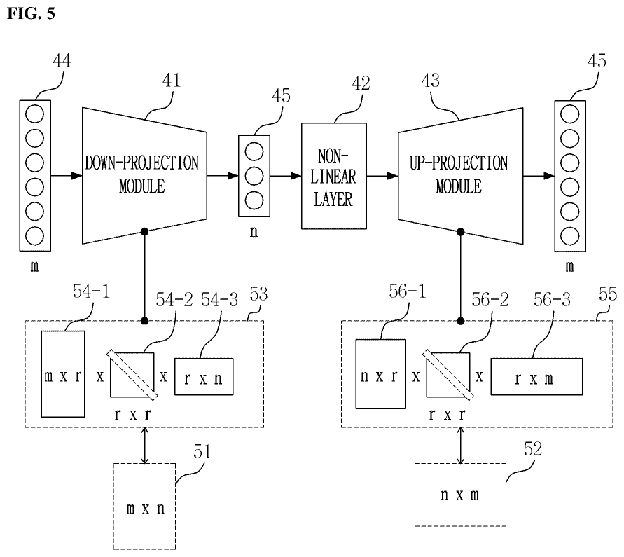

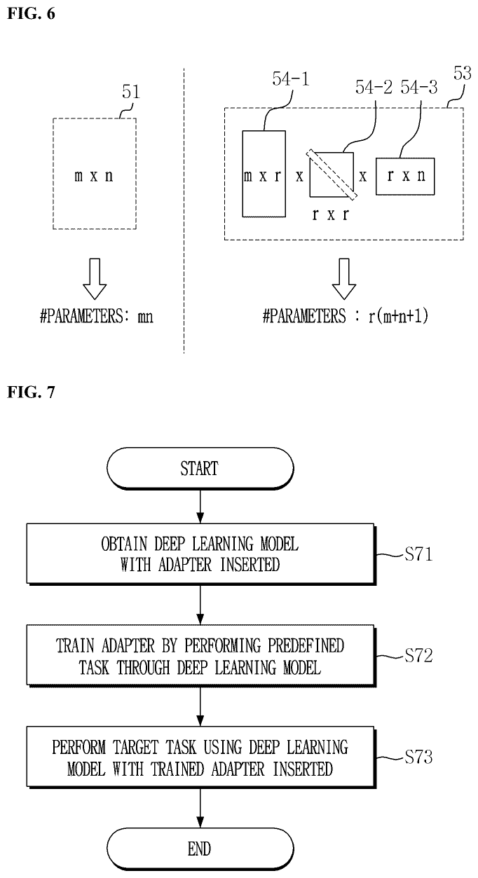

The down-projection module 41 may perform the down-projection operation using weight matrices (“53” in FIG. 5) based on trainable parameters (e.g., parameters of the linear layer). This will be described later with reference to FIGS. 5 and 6.

The non-linear layer 42 is a layer (or module) that performs a non-linear transformation (or operation). The non-linear layer 42 is configured to perform a non-linear transformation (or operation) on the data 45 passed through the down-projection module 41 (i.e., the result of the down-projection operation).

The non-linear layer 42 may be implemented based on a non-linear function, such as a Rectified Linear Unit (ReLU), but the present disclosure is not limited thereto.

The up-projection module 43 is a module that performs an up-projection operation (i.e., a projection operation involving dimensional expansion). For example, the up-projection module 43 may transform the data passed through the non-linear layer 42 (e.g., a vector obtained by the non-linear transformation) into higher-dimensional data 46 (e.g., a vector with more elements). The up-projection module 43 may be implemented based on at least one linear layer, but the present disclosure is not limited thereto.

The up-projection module 43 may also perform the up-projection operation using weight matrices (“55” in FIG. 5) based on the trainable parameters (e.g., the parameters of the linear layer). This will be described later with reference to FIGS. 5 and 6.

FIG. 4 illustrates a case where the data 46 output from the up-projection module 43 is aggregated (e.g., added or concatenated) with the input data 44 to form final output data of the adapter 20. However, the scope of the present disclosure is not limited to this.

The forms and characteristics of the weight matrices (53 and 55) held by the adapter 20 will hereinafter be described with reference to FIGS. 5 and 6. In the following description, the groups of weight matrices of the down-projection module 41 and the up-projection module 43 may be referred to as a first weight matrix group 53 and a second weight matrix group 55, respectively (where “first” and “second” may be omitted for simplicity).

FIG. 5 is a diagram for explaining the forms and characteristics of the weight matrices (53 and 55) held by the adapter 20 according to some embodiments of the present disclosure. In FIG. 5 and its relevant drawings, lowercase alphabets (e.g., “m,” “r,” “n”) indicate the size of weight matrices (e.g., 54-1) and the dimensions of data (e.g., vectors).

As illustrated in FIG. 5, the down-projection module 41 and the up-projection module 43 may perform a projection operation using the first weight matrix group 53 and the second weight matrix group 55, respectively (e.g., perform a down-projection operation through multiplication of the input data 44 by the first weight matrix group 53).

The first weight matrix group 53 may include a plurality of weight matrices 54-1 through 54-3 connected through a multiplication operation. In this case, the weight matrices 54-1 through 54-3 may be designed in the form of singular vector decomposition (SVD) matrices, e.g., truncated SVD matrices). For example, three matrices, including a diagonal matrix, may be connected through multiplication. Here, the design of the weight matrices 54-1 through 54-3 in the form of SVD matrices does not mean that the weight matrices 54-1 through 54-3 have been generated by decomposing an original matrix 51 through SVD (e.g., truncated SVD). Instead, it means that the weight matrices 54-1 through 54-3 have a form similar to matrices obtained through SVD. For reference, virtual original matrices 51 and 52 are depicted with dashed lines in FIG. 5.

FIG. 5 illustrates a case where the first weight matrix group 53 is composed of three weight matrices 54-1 through 54-3 in the form of SVD matrices, but the present disclosure is not limited thereto. Alternatively, other weight matrices may be included in the first weight matrix group 53. For ease of understanding, it is assumed that the first weight matrix group 53 consists of three weight matrices 54-1 through 54-3.

As illustrated, the weight matrix 54-1 of the first weight matrix group 53 may be designed as a matrix with a size of m×r, and the weight matrix 54-3 of the first weight matrix group 53 may be designed as a matrix with a size of r×n (where m, n, and r are natural numbers). Since the weight matrices 54-1 through 54-3 are used in a down-projection operation, the value of m may be set to be greater than the value of n (i.e., m>n).

Additionally, the weight matrix 54-2 of the first weight matrix group 53 may be designed as a diagonal matrix with r diagonal elements (where r is a natural number). In this case, the value of r may be set to be smaller than the values of m and n (i.e., r<min (m, n)).

In some embodiments, the value of r may be set to satisfy Equation 1 below. In this case, the number of parameters in the first weight matrix group 53 is reduced compared to the original matrix 51, thus further reducing training costs. This concept may also apply to the second weight matrix group 55. Specifically, as illustrated in FIG. 6, the total number of parameters in the first weight matrix group 53 is “r (m+n+1),” whereas the number of parameters in the original matrix 51 is “mn.” Therefore, if the value of r is set to satisfy Equation 1 below, the total number of parameters in the first weight matrix group 53 becomes smaller than that of the original matrix 51, thereby reducing the training costs compared to using the original matrix 51 (i.e., the first weight matrix group 53 performs the same functions as the original matrix 51 while requiring lower training costs).

$$r < \frac{m * n}{( n + m + 1 )} \qquad [ Equation 1 ]$$

Similar to the first weight matrix group 53, the second weight matrix group 55 may also include a plurality of weight matrices 56-1 through 56-3. The weight matrices 56-1 through 56-3 may also be designed in the form of SVD matrices. For details on each of the weight matrices 56-1 through 56-3, refer to the description of the first weight matrix group 53.

Designing (or expressing) the first and second weight matrix groups 53 and 55 of the down- and up-projection modules 41 and 43 in the form of SVD matrices may provide various advantages, as follows.

First, the parameters of the adapter 20, which adjusts the output of the deep learning model 11, are decomposed by component, making it easier and more accurate to identify which components are important. For example, it is possible to accurately determine which components are important based on the values of the diagonal elements in the diagonal weight matrices 54-2 and 56-2 (which may function as singular values).

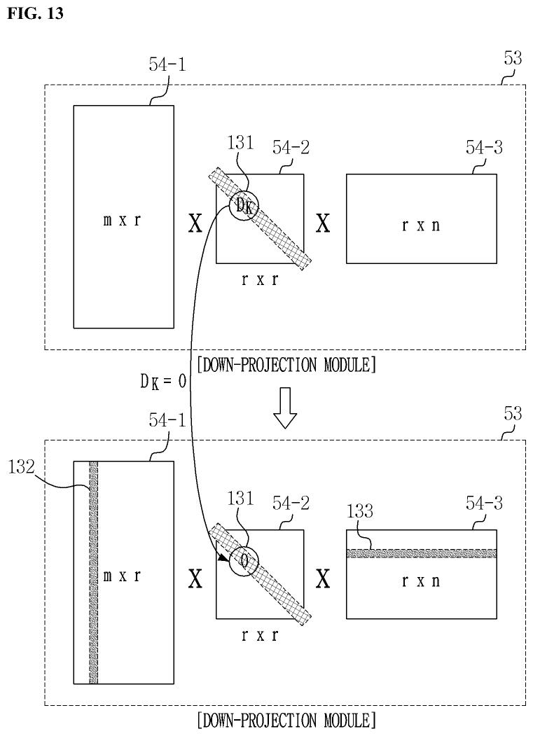

Second, controlling the filtering of non-critical components can be performed more easily and accurately based on the values of the diagonal elements in the diagonal weight matrices 54-2 and 56-2 (refer to the description of FIG. 13).

Third, training costs can be reduced compared to using the original matrices 51 and 52 that perform the same functions (refer to the description of FIG. 6).

Thus far, the structure and operation of the adapter 20 according to some embodiments of the present disclosure have been described with reference to FIGS. 4 through 6. Based on the above descriptions, various methods that can be performed in the model tuning system 10 will now be explained.

For ease of understanding, it is assumed that all steps/operations of the following methods are performed in the model tuning system 10 (hereinafter, “the system 10”). Therefore, if the subject of a specific step/operation is omitted, it is understood that the system 10 performs the specific step/operation. However, some steps of the following methods may be performed on different computing devices in practical environments.

Additionally, for better understanding, it is assumed that the adapter 20 with the structure illustrated in FIGS. 4 and 5 is inserted into the deep learning model 11, and that the deep learning model 11 is a transformer-based LLM.

FIG. 7 is a flowchart illustrating a model tuning method according to some embodiments of the present disclosure. However, this is merely exemplary for achieving the purpose of the present disclosure, and some steps may be added or deleted as needed.

As illustrated in FIG. 7, the model tuning method according to some embodiments may start with step S71 of obtaining the deep learning model 11 into which the adapter 20 is inserted. As described above, at least one adapter 20 may be inserted into at least one layer (i.e., transformer layer) of the deep learning model 11, and the number of adapters 20 inserted and their insertion positions may vary. As described above, the deep learning model 11 refers to a pretrained model.

The structure of a transformer-based deep learning model 11 is illustrated in FIG. 8.

As illustrated in FIG. 8, the deep learning model 11 may include a plurality of transformer layers 81-1 through 81-N and may be configured to receive text 82 as input and output a corresponding embedding 83 (e.g., an embedding vector). For example, the deep learning model 11 may receive the text 82 in units of tokens (e.g., receive the embedding of each token) and output an embedding in units of the tokens (i.e., output a token embedding) (e.g., as in Bidirectional Encoder Representations from Transformers (BERT), but the present disclosure is not limited thereto. The embedding 83 may refer to a representative embedding of the text 82 (e.g., an embedding corresponding to a CLS token) or a token embedding corresponding to a specific token. Alternatively, the embedding 83 may refer to multiple token embeddings.

In a case where the deep learning model 11 is configured as illustrated in FIG. 8, the adapter 20 may be inserted into at least one transformer layer (e.g., the transformer layer 81-1). For example, as illustrated in FIG. 9, it is assumed that a transformer layer 81 includes an attention module (refer to “multi-head attention”) and two feed-forward layers. In this case, two adapters 20-1 and 20-2 may be respectively inserted after the two feed-forward layers to adjust their outputs. Since a feed-forward layer aggregates input data, inserting an adapter (e.g., the adapter 20-1) after the feed-forward layer may enhance the effect of output adjustment by the adapter. The detailed configurations and operating principles of the modules/layers (e.g., multi-head attention, feed-forward layers, layer norms, etc.) constituting the transformer layer 81 are already well known in the art to which the present disclosure pertains, and thus, descriptions thereof will be omitted.

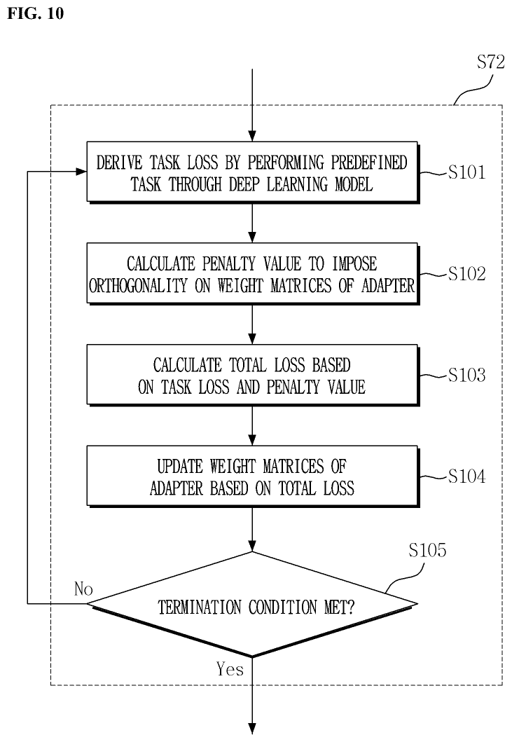

Referring back to FIG. 7, in step S72, the adapter 20 is trained by performing a predefined task through the deep learning model 11. For example, the system 10 may tune the deep learning model 11 by updating the first and second weight matrix groups 53 and 55 of the adapter 20 instead of the parameters of the deep learning model 11. Step S72 corresponds to the process of fine-tuning the deep learning model 11. A detailed process for step S72 is illustrated in FIG. 10.

FIG. 10 is a detailed flowchart illustrating step S72 described earlier.

Referring to FIG. 10, in step S101, task loss is derived by performing a predefined task through the deep learning model 11. Any task may be used for tuning the deep learning model 11. For example, the system 10 may tune the deep learning model 11 using at least one task from a variety of tasks related to classification, regression, or generation. These tasks for tuning may or may not include the target task of an inference process.

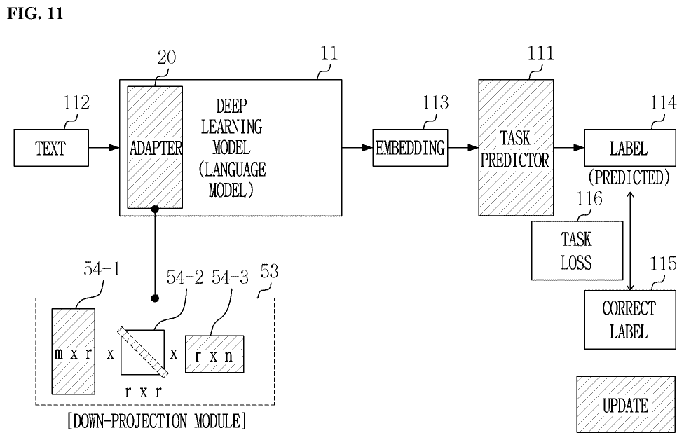

FIG. 11 illustrates the process of performing a task (i.e., a task for tuning) through the deep learning model 11 illustrated in FIG. 8. FIG. 11 depicts only the weight matrix group of the down-projection module 41, i.e., the first weight matrix group 53, among the weight matrix groups of the adapter 20.

As illustrated in FIG. 11, the system 10 may generate an embedding 113 (e.g., a representative embedding of the text sample 112 or an embedding of a specific token) by inputting a text sample 112 into the deep learning model 11, and may predict a label 114 for a task by inputting the embedding 113 into a corresponding task predictor 111. If the task is a classification task, the predicted label 114 may be, for example, a confidence score for each class. If the task is a regression task, the predicted label 114 may be, for example, a real number prediction value.

Thereafter, the system 10 may calculate task loss 116 based on the difference between the predicted label 114 and a correct label 115. For example, the system 10 may calculate the task loss 116 using a loss function suitable for the type of the task (e.g., cross-entropy loss function for a classification task or a mean square error loss function for a regression task).

The task predictor 111 may be configured (or implemented) with various structures/types of neural networks. For example, the task predictor 111 may include at least one fully connected layer, but the present disclosure is not limited thereto. The task predictor 111 may or may not be considered a component of the deep learning model 11.

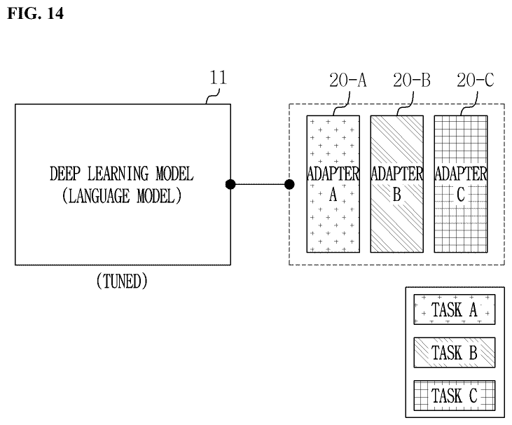

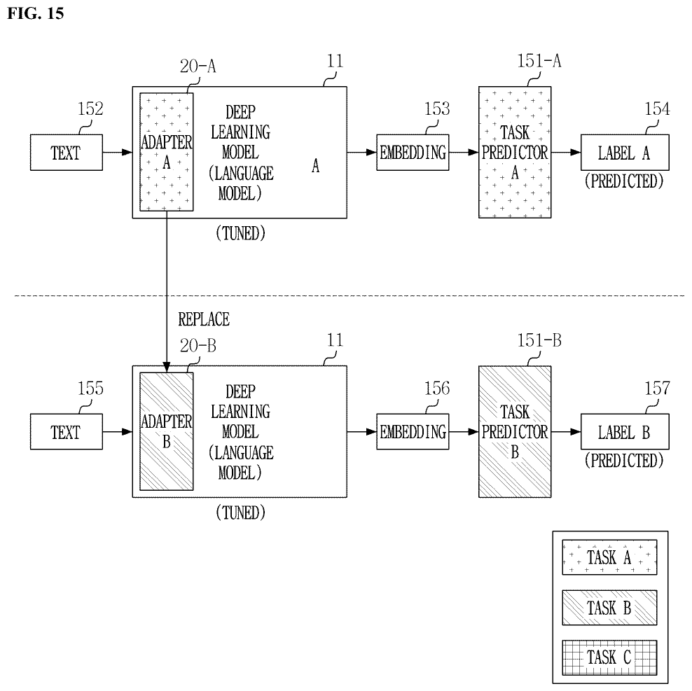

FIG. 11 illustrates a case where the deep learning model 11 is tuned using only one task predictor 111. However, in some embodiments, multiple task predictors may be used for tuning the deep learning model 11. For example, the system 10 may perform a first task through a first task predictor (e.g., 111) to calculate a first task loss and perform a second task through a second task predictor to calculate a second task loss. In this case, the system 10 may perform the first task with a first adapter (e.g., 20) inserted into the deep learning model 11 and then replace the first adapter with a second adapter to perform the second task. In other words, the system 10 may use different adapters (e.g., 20) for different tasks when tuning the deep learning model 11, thereby building task-specific adapters (e.g., 20). This will be described later in further detail with reference to FIGS. 14 and 15.

Referring back to FIG. 10, in steps S102 and S103, a penalty value is calculated to impose orthogonality on the weight matrices (e.g., 54-1) of the adapter 20. Then, based on the task loss and the penalty value, total loss is calculated. For example, the system 10 may calculate the total loss by aggregating the task loss and the penalty value using an appropriate method (e.g., summation or weighted sum).

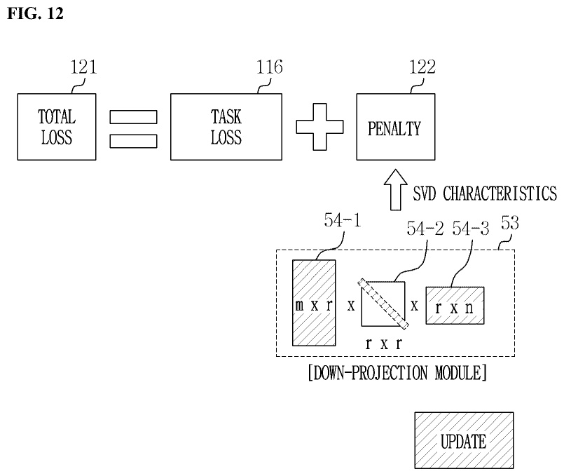

The penalty value may be understood as a value imposed to ensure that each of the first and second weight matrix group 53 and 55 has the characteristics of SVD matrices (i.e., orthogonality). For better understanding, additional explanation will hereinafter be provided with reference to FIG. 12.

As illustrated in FIG. 12, for the first weight matrix group 53 of the down-projection module 41 to have the characteristics of SVD matrices, the weight matrices 54-1 and 54-3 need to be orthogonal (e.g., the product of the weight matrix 54-1 and its transpose needs to be an identity matrix). To achieve this, the system 10 may calculate a penalty value 122 to impose orthogonality on the two weight matrices 54-1 and 54-3 through a separate regularization term (e.g., the lower the degree of orthogonality, the greater the penalty value 122). The system 10 may then calculate total loss 121 by aggregating the penalty value 122 with the task loss 116. A penalty value (e.g., 122) may also be calculated for the second weight matrix group 55 of the up-projection module 43.

For example, the system 10 may calculate a penalty value (e.g., 122) for the weight matrices 54-1 and 54-3 according to Equation 2 below. Similarly, the system 10 may calculate a penalty value (e.g., 122) for the weight matrices 56-1 and 56-3 of the up-projection module 43 in the same manner. However, the scope of the present disclosure is not limited to this.

$$ℛ = {‖ {( {Q}_{d}^{l} )}^{T} {Q}_{d}^{l} - I ‖}_{F} + {‖ {{V}_{d}^{l} ( {V}_{d}^{l} )}^{T} - I ‖}_{F} \qquad [ Equation 2 ]$$

Equation 2 represents a regularization term for calculating a penalty value related to orthogonality based on the Frobenius norm. In Equation 2, R represents the penalty value, Q_{d} and V_{d} represent the weight matrices 54-1 and 54-3, respectively, and I represents an identity matrix.

Steps S101 through S103 correspond to the process of calculating total loss using a loss function with a regularization term (see Equation 2) added to impose the characteristics of SVD matrices.

In step S104, based on the total loss, the weight matrices of the adapter 20 (i.e., the first and second weight matrix groups 53 and 55) are updated. For example, referring back to FIG. 11, the system 10 may update the values of the first and second weight matrix groups 53 and 55 based on the total loss while keeping the entire parameters (or some parameters) of the deep learning model 11 frozen. In this case, the parameters of the task predictor 111 may also be updated. In some embodiments, the system 10 may update the values of the first and second weight matrix groups 53 and 55 based on the total loss while keeping only some of the parameters of the deep learning model 11 frozen.

In step S105, it is determined whether a termination condition is satisfied. If the termination condition is met, the tuning of the deep learning model 11 ends. Otherwise, steps S101 through S104 are repeated using different data (e.g., text samples) from the training set.

The termination condition may be defined based on, for example, the size of loss, the number of epochs, or training time, but the scope of the present disclosure is not limited thereto.

In some embodiments, the system 10 may exclude some parameters of the adapter 20 (i.e., parameters corresponding to non-critical components) from the parameters targeted for updates, based on the impact of the diagonal elements of the diagonal weight matrices 54-2 and 56-2 on the task (or the predicted label). In this manner, the computing and time costs required for tuning the deep learning model 11 can be further reduced. This will hereinafter be described with reference to FIG. 13.

FIG. 13 is a diagram for explaining an adapter parameter filtering method according to some embodiments of the present disclosure. FIG. 13 depicts only the weight matrix group of the down-projection module 41, i.e., the first weight matrix group 53, among the weight matrix groups of the adapter 20.

Referring to FIG. 13, during the update of the values of the weight matrix group 53 of the adapter 20 through a task, the system 10 may calculate (or measure) the impact of each diagonal element (e.g., 131) of the diagonal weight matrix 54-2 on the task (or the predicted label for the task). For example, the system 10 may calculate the impact of each diagonal element (e.g., 131) on the task (or the predicted label) based on the gradient between the level of the predicted label and each diagonal element. The gradient representing the impact of each diagonal element on the predicted label may be readily understandable to one of ordinary skill in the art to which the present disclosure pertains, and thus, a detailed explanation thereof will be omitted.

Specifically, the impact of each diagonal element (e.g., 131) may be calculated because when the first weight matrix group 53 satisfies the characteristics of SVD matrices, the value of each diagonal element (e.g., 131) may function as a singular value, representing the importance of the corresponding component.

Thereafter, the system 10 may select diagonal elements (e.g., 131) from the diagonal weight matrix 54-2 whose impact falls below a threshold (e.g., select the bottom 10% of the diagonal elements). FIG. 13 illustrates a case where one diagonal element 131 is selected.

Thereafter, the system 10 may set the value of the selected diagonal element 131 to zero. In this case, the parameters (i.e., 132 and 133) corresponding to the component represented by the diagonal element 131 are automatically excluded from the parameters targeted for updates, thereby further reducing the computing and time costs required for training the adapter 20 (or tuning the deep learning model 11). In other words, by setting the value of the diagonal element 131 with low impact on the predicted label to zero, the system 10 can filter out (or exclude) the parameters of the adapter 20 corresponding to the non-critical component, resulting in a more cost-effective tuning process for the deep learning model 11.

The aforementioned description may also apply to the second weight matrix group 55 of the up-projection module 43.

Thus far, the adapter parameter filtering method according to some embodiments of the present disclosure has been described with reference to FIG. 13.

Referring back to FIG. 7, in step S73, a target task is performed using the deep learning model 11 (hereinafter, “the tuned deep learning model 11”) with the trained adapter 20 inserted thereinto. For example, the system 10 may perform a target task using the tuned deep learning model 11 and a corresponding task predictor (e.g., 111) for the target task. Further details can be found in the description of FIG. 11.

In some embodiments, the system 10 may replace the adapter 20 inserted into the deep learning model 11 with a new trained adapter and perform another target task using the new adapter. In other words, the system 10 may perform various target tasks by replacing the adapter 20 with other adapters during an inference process, and this will hereinafter be described with reference to FIGS. 14 and 15.

FIGS. 14 and 15 are diagrams for explaining an adapter replacement-based target task execution method according to some embodiments of the present disclosure. In FIGS. 14 and 15, it is assumed that the deep learning model 11 is an LLM.

As illustrated in FIG. 14, it is assumed that the deep learning model 11 has been tuned using three tasks A, B, and C, and that different adapters 20-A, 20-B, and 20-C have been used for the tasks A, B, and C, respectively, during the tuning process. Furthermore, it is assumed that all the three tasks A, B, and C correspond to target tasks (i.e., tasks performed during an inference process). For clarity in the present disclosure, the three tasks A, B, and C will hereinafter be referred to as first, second, and third tasks A, B, and C, respectively, and the adapters 20-A, 20-B, and 20-C will hereinafter be referred to as first, second, and third adapters 20A, 20B, and 20C, respectively.

The first adapter 20-A may be interpreted to encompass one or more adapters used to tune the deep learning model 11 through the first task (and may thus be referred to as a first adapter set 20-A). Similarly, the second adapter 20-B may also be interpreted to encompass one or more adapters used to tune the deep learning model 11 through the second task, and the third adapter 20-C may also be interpreted to encompass one or more adapters used to tune the deep learning model 11 through the third task.

In this case, the system 10 may perform the first task using the deep learning model 11 with the first adapter 20-A inserted thereinto and a first task predictor 151-A. For example, the system 10 may generate an embedding 153 corresponding to the text 152 by inputting text 152 into the deep learning model 11, and may predict a label 154 for the first task by inputting the embedding 153 into the first task predictor 151-A.

Thereafter, the system 10 may remove the first adapter 20-A from the deep learning model 11 and insert the second adapter 20-B into the deep learning model 11. The system 10 may then perform the second task using the deep learning model 11 with the second adapter 20-B inserted thereinto. For example, the system 10 may generate an embedding 156 corresponding to the text 155 by inputting text 155 into the deep learning model 11, and may predict a label 157 for the second task by inputting the embedding 156 into the second task predictor 151-B.

Similarly, the system 10 may replace the second adapter 20-B with the third adapter 20-C and further perform the third task.

Thus far, the adapter replacement-based target task execution method has been described with reference to FIGS. 14 and 15. As described above, during the tuning of the deep learning model 11, an adapter (e.g., 20-A) can be trained for each task, and different target tasks can be performed during an inference process by replacing the adapter (e.g., 20-A) in the deep learning model 11. In this manner, various target tasks can be performed easily and accurately.

The model tuning method according to some embodiments of the present disclosure has been described so far with reference to FIGS. 7 through 15. As described above, the deep learning model 11 can be tuned by inserting a lightweight adapter 20 into the pretrained deep learning model 11 and updating the parameters of the adapter 20 instead of the deep learning model 11. In this case, the computing and time costs required for tuning the deep learning model 11 can be significantly reduced. For example, even an LLM can be tuned for a specific purpose at a lower cost, thereby improving the usability of the LLM.

Additionally, through adapter-based model tuning, a high-performance deep learning model 11 suitable for a target task (or domain) can be easily constructed (refer to Table 2).

Furthermore, by designing the first and second weight matrix groups 53 and 55 of the adapter 20 in the form of SVD matrices, the costs required for training the adapter 20 can be further reduced.

Moreover, by updating the first and second weight matrix groups 53 and 55 of the adapter 20 based on a regularization term that enforces the characteristics of SVD matrices, the parameters of the adapter 20 (i.e., the parameters of the weight matrices) can be accurately separated by component. In this case, it is possible to accurately identify which components are important based on the values of the diagonal elements in the diagonal weight matrices 54-2 and 56-2.

The experimental results regarding the performance of the aforementioned model tuning method (hereinafter, “the proposed method”) will hereinafter be briefly discussed.

The inventors of the present disclosure conducted experiments to verify the performance of the proposed method. Specifically, the inventors inserted adapters (e.g., 20) with the structures illustrated in FIGS. 4 and 5 into four layers of an LLaMA-2 model and tuned the LLaMA-2 model, as illustrated in FIGS. 7 through 12. For a task for tuning, the task (hereinafter, “the recommended API information generation task”) of generating information on a relevant PyTorch Application Programming Interface (API) suitable for the given problem was used.

For reference, the LLaMA-2 model is an LLM (i.e., a pretrained model) released by Meta, which contains approximately 7 billion parameters. The input and output of the LLaMA-2 model for the recommended API information generation task are shown in Table 1 below.

TABLE 1

| Input | Output |
|---|---|
| What is an API that can | Output: { |
| be used to classify sports | “domain”: “Video Classification”, |
| activities in videos? | “api_call”: “torch.hub.load(repo_or_dir= |
| | ‘facebookresearch/pytorchvideo’, |
| | model=‘slow_r50’, pretrained=True)”, |
| | “api_provider”: “PyTorchVideo”} |

Then, the inventors conducted an experiment comparing the performance of the tuned LLaMA-2 model with that of a Gorilla model. The inventors compared the two models in terms of accuracy and hallucination. Accuracy was measured based on the ratio of generating information on APIs suitable for the given problem among the actual PyTorch APIs. Hallucination was measured based on the ratio of generating information on non-existent PyTorch APIs. The comparison between the generated PyTorch API information and the actual PyTorch API information was performed by comparing the Abstract Syntax Tree (AST) of the two APIs.

For reference, the Gorilla model is a model obtained by fine-tuning the LLaMA-2 itself using the recommended API information generation task. Further details can be found in the paper entitled “Gorilla: Large Language Model Connected with Massive APIs.”

The performance experimental results are presented in Table 2 below.

TABLE 2

| Category | Gorilla | Proposed Method |
|---|---|---|
| Accuracy | 59.13% | 94.62% |
| Hallucination | 6.98% | 1.61% |

Referring to Table 2, it can be confirmed that the performance of the LLaMA-2 model tuned according to the proposed method significantly surpasses that of the Gorilla model in both accuracy and hallucination aspects. This demonstrates that the proposed method can build a high-performance deep learning model while requiring lower computational costs compared to general fine-tuning techniques.

The experimental results regarding the performance of the proposed method have been briefly explained so far. Hereinafter, an exemplary computing device 160 capable of implementing the system 10 described above will be explained with reference to FIG. 16.

FIG. 16 is an illustrative hardware configuration diagram illustrating the computing device 160.

Referring to FIG. 16, the computing device 160 may include at least one processor 161, a system bus 163, a communication interface 164, a memory 162, which loads a computer program 166 executed by the processor 161, and a storage 165, which stores the computer program 166. Even though FIG. 16 depicts only components related to the embodiments of the present disclosure, it is obvious to one of ordinary skill in the art to which the present disclosure pertains that the computing device 160 may further include other generic components, in addition to the components depicted in FIG. 16. Moreover, in some embodiments, the computing device 160 may be configured with some of the components depicted in FIG. 16 omitted. The components of the computing device 160 will hereinafter be described.

The processor 161 may control the overall operation of each of the components of the computing device 160. The processor 161 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 161 may perform computations for at least one application or program to execute operations/methods according to some embodiments of the present disclosure. The computing device 160 may be equipped with one or more processors.

The memory 162 may store various data, commands, and/or information. The memory 162 may load the computer program 166 from the storage 165 to execute the operations/methods according to some embodiments of the present disclosure. The memory 162 may be implemented as a volatile memory such as a random-access memory (RAM), but the present disclosure is not limited thereto.

The bus 163 may provide communication functionality between the components of the computing device 160. The bus 163 may be implemented in various forms such as an address bus, a data bus, and a control bus.

The communication interface 164 may support wired or wireless Internet communication of the computing device 160. Additionally, the communication interface 164 may also support various other communication methods. To this end, the communication interface 164 may be configured to include a communication module well-known in the technical field of the present disclosure.

The storage 165 may non-transitorily store at least one computer program 166. The storage 165 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 166, when loaded into the memory 162, may include one or more instructions that enable the processor 161 to perform the operations/methods according to some embodiments of the present disclosure. That is, by executing the loaded one or more instructions, the processor 161 may perform the operations/methods according to some embodiments of the present disclosure.

For example, the computer program 166 may include instructions for performing the operations of obtaining a deep learning model 11 into which an adapter 20 is inserted, performing a specific task on the deep learning model 11 to calculate loss, and updating a plurality of weight matrices (e.g., 53) of the adapter 20 based on the calculated loss.

In another example, the computer program 166 may include instructions for performing at least some of the steps, operations, or methods described with reference to FIGS. 1 through 15.

As illustrated, the system 10 according to some embodiments of the present disclosure can be implemented through the computing device 160.

Meanwhile, in some embodiments, the computing device 160 of FIG. 16 may refer to a virtual machine implemented based on cloud technology. For example, the computing device 160 may be a virtual machine operating on one or more physical servers included in a server farm. In this example, at least some of the processor 161, the memory 162, and the storage 165 may be virtual hardware, and the communication interface 164 may also be implemented as a virtualized networking element such as a virtual switch.

The computing device 160 capable of implementing the model tuning system 10 according to some embodiments of the present disclosure has been explained so far with reference to FIG. 16.

Various embodiments of the present disclosure and their effects have been described so far with reference to FIGS. 1 through 16.

According to some embodiments of the present disclosure, a deep-learning model can be tuned by inserting a lightweight adapter into a pretrained deep learning model and updating the parameters of the adapter instead of the parameters of the pretrained deep learning model. In this case, the computational and time costs required for tuning the deep learning model can be significantly reduced. For example, even an LLM can be tuned for specific purposes at a lower cost, thereby improving the usability of the LLM.

Additionally, a high-performance deep-learning model suitable for a target task (or domain) can be easily constructed through adapter-based model tuning (see Table 2).

Furthermore, by designing the adapter's weight matrices in the form of singular vector decomposition (SVD) matrices, the costs associated with training the adapter can be further reduced.

Moreover, by updating the adapter's weight matrices based on a regularization term that imposes the characteristics of the SVD matrices, the adapter's parameters (i.e., the parameters of the weight matrices) can be precisely separated by component. In this case, the importance of each given component can be accurately identified based on the values of diagonal elements in a diagonal weight matrix.

Additionally, the impact of the diagonal elements on a predicted label (i.e., the importance of the components represented by the diagonal elements) can be accurately calculated (or measured) using the gradient between the values of the diagonal elements and the value of the predicted label.

Furthermore, by setting the values of low-impact diagonal elements to ‘0,’ the adapter's parameters corresponding to non-critical components can be excluded from the parameters targeted for updates. In this case, the computational and time costs required for tuning the deep learning model can be further reduced.

Finally, by training the adapter for each task during the tuning of the deep learning model and performing different target tasks while replacing the adapter with another during inference, various target tasks can be easily and accurately executed.

It should be noted that the effects of the present disclosure are not limited to those described above, and other effects of the present disclosure will be apparent from the following description.

The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for model tuning performed by at least one processor, the method comprising:
obtaining a deep learning model into which an adapter is inserted, wherein the adapter is a module inserted to adjust the output of the deep learning model using a plurality of weight matrices, and the plurality of weight matrices include a diagonal weight matrix;
calculating loss by performing a specific task on the deep learning model; and
updating the plurality of weight matrices of the adapter based on the loss.

2. The method of claim 1, wherein the adapter includes:
a down-projection module that performs a down-projection operation using some of the plurality of weight matrices;
a non-linear layer that performs a non-linear transformation on a result of the down-projection operation; and
an up-projection module that performs an up-projection operation on a result of the non-linear transformation using other weight matrices of the plurality of weight matrices.

3. The method of claim 1, wherein
the plurality of weight matrices further include a first weight matrix and a second weight matrix that are connected to the diagonal weight matrix through a multiplication operation,
the diagonal weight matrix is an r×r matrix where r is a natural number,
the first weight matrix is an m×r matrix where m is a natural number,
the second weight matrix is an r×n matrix where n is a natural number, and
a value of r is set to be smaller than values of m and n.

4. The method of claim 3, wherein the value of r is set to satisfy the following equation:
r<(m*n)/(n+m+1).

5. The method of claim 1, wherein
the deep learning model includes a transformer layer,
the transformer layer includes an attention module and a feed-forward layer, and
the adapter is inserted after the feed-forward layer and configured to adjust the output of the feed-forward layer.

6. The method of claim 1, wherein
the deep learning model includes a plurality of neural network layers,
the adapter is inserted to adjust the output of a first neural network layer among the plurality of neural network layers, and
another adapter is further inserted into the deep learning model to adjust the output of a second neural network layer among the plurality of neural network layers.

7. The method of claim 1, wherein the plurality of weight matrices further include a first weight matrix and a second weight matrix that are connected to the diagonal weight matrix through a multiplication operation, and
wherein the calculating the loss comprises:
deriving task loss by performing the specific task;
calculating a penalty value to impose orthogonality on at least one of the first weight matrix or the second weight matrix; and
calculating the loss based on the task loss and the penalty value.

8. The method of claim 1, wherein the diagonal weight matrix includes a plurality of diagonal elements, and
the method further comprises:
calculating an impact of each of the plurality of diagonal elements on a predicted label for the specific task based on a gradient between a value of the predicted label and each of the plurality of diagonal elements; and
setting a value of any diagonal element whose impact falls below a threshold to zero.

9. The method of claim 1, wherein the updating the plurality of weight matrices comprises:
updating the plurality of weight matrices while keeping at least part of the deep learning model frozen.

10. The method of claim 1, wherein the adapter is a first adapter, and
the method further comprises:
inserting a second adapter into the deep learning model and updating the second adapter by performing a different task;
performing the specific task using the deep learning model with the updated first adapter inserted thereinto;
removing the updated first adapter from the deep learning model and inserting the updated second adapter into the deep learning model; and
performing the different task using the deep learning model with the updated second adapter inserted thereinto.

11. A system for model tuning, the system comprising:
at least one processor; and
a memory configured to store a computer program executed by the at least one processor,
wherein the computer program comprises instructions for performing operations of:
obtaining a deep learning model into which an adapter is inserted, wherein the adapter is a module inserted to adjust an output of the deep learning model using a plurality of weight matrices, and the plurality of weight matrices include a diagonal weight matrix;
calculating loss by performing a specific task on the deep learning model; and
updating the plurality of weight matrices of the adapter based on the loss.

12. The system of claim 11, wherein the adapter includes:
a down-projection module that performs a down-projection operation using some of the plurality of weight matrices;
a non-linear layer that performs a non-linear transformation on a result of the down-projection operation; and
an up-projection module that performs an up-projection operation on a result of the non-linear transformation using other weight matrices of the plurality of weight matrices.

13. The system of claim 11, wherein
the plurality of weight matrices further include a first weight matrix and a second weight matrix that are connected to the diagonal weight matrix through a multiplication operation,
the diagonal weight matrix is an r×r matrix where r is a natural number,
the first weight matrix is an m×r matrix where m is a natural number,
the second weight matrix is an r×n matrix where n is a natural number, and
a value of r is set to be smaller than values of m and n.

14. The system of claim 11, wherein
the deep learning model includes a transformer layer,
the transformer layer includes an attention module and a feed-forward layer, and
the adapter is inserted after the feed-forward layer and configured to adjust an output of the feed-forward layer.

15. The system of claim 11, wherein the plurality of weight matrices further include a first weight matrix and a second weight matrix that are connected to the diagonal weight matrix through a multiplication operation, and
wherein the operation of calculating the loss comprises:
deriving task loss by performing the specific task;
calculating a penalty value to impose orthogonality on at least one of the first weight matrix or the second weight matrix; and
calculating the loss based on the task loss and the penalty value.

16. The system of claim 11, wherein the diagonal weight matrix includes a plurality of diagonal elements, and
the computer program further comprises instructions for performing operations of:
calculating an impact of each of the plurality of diagonal elements on a predicted label for the specific task based on a gradient between a value of the predicted label and each of the plurality of diagonal elements; and
setting a value of any diagonal element whose impact falls below a threshold to zero.

17. The system of claim 11, wherein the operation of updating the plurality of weight matrices comprises:
updating the plurality of weight matrices while keeping at least part of the deep learning model frozen.

18. A non-transitory computer-readable recording medium storing a computer program, which, when executed by at least one processor, causes the at least one processor to perform:
obtaining a deep learning model into which an adapter is inserted, wherein the adapter is a module inserted to adjust an output of the deep learning model using a plurality of weight matrices, and the plurality of weight matrices include a diagonal weight matrix;
calculating loss by performing a specific task on the deep learning model; and
updating the plurality of weight matrices of the adapter based on the loss.
